(19) United States
(12) Patent Application Publication
(10) Pub. No.: US 2016/0153871 A1
(43) Pub. Date: Jun. 2, 2016

(54) Cytoplasmic Stain Composition

(71) Applicant: Jerry Fredenburgh, Carson City, NV (US)

(72) Inventor: Jerry Fredenburgh, Carson City, NV (US)

(21) Appl. No.: 14/556,125

(22) Filed: Nov. 29, 2014

(51) Int. Cl. G01N 1/30

(52) U.S. Cl. CPC G01N 1/30; G01N 2001/302

(57) ABSTRACT

Disclosed is a composition of cytoplasm stain for use in differentiation of cell nuclei from cell cytoplasmic components and differentiation of specific cytoplasm components by tinctorial contrast. Specifically, the invention relates to stain composition utilized as a counter stain in the hematoxylin and eosin procedure for use in histological and cytological microscopic evaluation of tissue and cells. The stain composition includes eosin-Y as the sole dye in the composition, a propylene glycol solvent and an organic buffer.

### CROSS-REFERENCE TO RELATED APPLICATIONS

This application is a continuation-in-part of: U.S. patent application Ser. No. 13/781,944, entitled “cytoplasmic stain composition”, filed on Mar 1, 2013; the disclosures of which are incorporated by reference herein as if set forth in their entirety.

### BACKGROUND OF THE INVENTION

1. Field of the Invention

The present invention relates to the field of biological stains and compositions useful for producing such stains. Specifically, the invention relates to cytoplasmic stains utilized in the hematoxylin and eosin staining technique for use in histology and cytology. In the hematoxylin and eosin technique, the cytoplasmic stain is referred to as the counter stain.

The composition of the present invention is used to provide differentiating contrast between nuclei/nuclear chromatin and cytoplasm. Tinctorial differentiation of specific cytoplasmic elements is also demonstrated. The invention is most generally used in the hematoxylin and eosin staining procedure but is not limited to this procedure alone.

2. Description of Related Art

In the preparation of histology and cytology tissue and cell samples for microscopic analysis, dyes have been used to stain tissues, cells, and cell components to facilitate their examination with light microscopy. The dyes stain cellular components with different tinctorial colors, differentiating the cell components. Therefore, stains are employed to differentiate cell components chromatically.

Staining solutions such as eosin have been used for some time with satisfactory results, although there has been a need for stains possessing greater transparency and clarity. In particular, when acid dye staining solutions such as eosin-Y, is used as cytoplasmic chromogen markers, there is at times an evident lack of cytoplasmic discrimination. Such condition is commonly referred to as muddy cytoplasm staining. The lack of discrimination is in part due to the pH of the staining solution.

Eosin-Y is the sodium salt of an acid dye complex containing color. Eosin-Y has a chromophore located in the anionic part of their molecule. Eosin-Y is fully charged at about pH 7.

The staining intensity of Eosin-Y is highly pH dependent. Experimental studies have shown that when the pH is above 5 the staining intensity drops significantly. The increase in pH will interfere with the uptake of the dye into the tissue and weak staining of eosin is observed.

U.S. Pat. No. 8,445,284 discloses a formulation for preparation of biological specimens, and more particularly to fixing, staining, and rinsing formulations. In this patent, a cytological staining solution comprising about 0.75 g/L Eosin Y; about 50 mM bis-tris buffer; about one mL/L polysorbate 20; about four g/L sodium chloride; about 10 mL/L ethylene glycol; about 15 ppm ProClin 300®; acetic acid; and water, and the solution has a pH of from about 5.8 to about 6.2. However, the cytological staining solution with the pH of greater than 5 does not provide better differentiation of the tissue elements and the various components of biological tissue cannot be viewed clearly.

In staining solution of eosin-Y, the amount of charged dye ions in a staining solution below pH 4 will greatly decrease because eosin-Y is converted to a free acid. The free acid moieties in a staining solution below pH 4 will nonspecifically bind to cell cytoplasm due to hydrogen bonding. When this occurs, the tissue section appears muddy with the loss of transparency, which is evident.

Staining solutions of a pH range of about pH 4.0-5.0 maintains a net cationic charge on cytoplasmic protein and does not allow formation of the free acid moiety that forms below pH 4.0. Thus, an optimal pH permits better differentiation of the tissue elements, and intelligent variations in the staining technique with the buffer described in the invention herein.

Traditional staining solutions of eosin-Y, consist of an alcoholic solution of the dye or dyes where acetic acid has been added. The pH of traditional staining solutions varies with the number of slides processed though the staining solution, the age of the staining solution, and the amount of acetic acid added. In such traditional staining solutions, a buffer is not employed.

Traditional alcoholic solutions of eosin-Y utilize ethyl alcohol or methyl alcohol as the dye solvent. The alcohol solvents allow for solvent evaporation which increases the dye content in the staining solution. An increase in dye concentration allows for tinctorial inconsistencies in cytoplasmic staining from day to day.

Alcoholic solvents are also flammable, increasing the threat of a fire hazard in the laboratory. Hazardous shipping fees are also charged when these staining solutions are shipped via commercial transportation in containers of more than 1 liter. The use of propylene glycol as the dye solvent decreases the evaporation rate of the dye solvent, thus maintaining a more consistent dye concentration in the staining solution which results in a more consistent cytoplasmic stain from day to day.

Accordingly, there is a need for an improved cytoplasmic stain composition utilized in the hernatoxylin and eosin staining technique for providing more accurate differentiating contrast between nuclei/nuclear chromatin and cytoplasm at an optimal pH. It is evident that there is an unmet need for cytoplasmic stain composition that would be non-hazardous, and more consistent.

### SUMMARY OF THE INVENTION

An object of the present invention is to provide a biological cytoplasmic stain for more accurate staining of cytoplasmic elements of cells for microscopic analysis and/or study.

Stains prepared by the composition of this invention are pH stable, less hazardous, and provides more consistent staining results.

The stain composition of the present invention enables cytoplasm and specific cytoplasmic elements to be differentiated with consistent tinctorial results.

In another object of the present invention, the composition includes eosin-Y as the sole dye, with an organic buffer in a propylene glycol solvent. The invention is generally used in the hematoxylin and eosin staining technique but is not limited to this procedure alone.

The principal objective of the present invention is to provide pH balanced cytoplasmic biological staining reagents that assure a consistent, clear and reproducible tinctorial cytoplasmic differentiation with the absence of muddy cytoplasm staining when tissue fixation is proper.

Another principal objective is to provide cytoplasmic differentiation with the aforesaid buffered glycol eosin-Y staining reagent, resulting in cytoplasm staining of various shades of pink; collagen pink, muscle fibers deep pink, red blood cells orange/red, fibrin deep pink, and when prominent nucleoli are present in properly fixed cells, the nucleoli-stains red.

It is another objective to provide buffered cytoplasmic biological staining reagents that assure longer shelf-life without a shift in pH which has a definite impact on cytoplasmic staining quality.

A further objective is to provide a non-flammable staining reagent to decrease physical hazards in the laboratory.

It is yet a further objective to provide a non-flammable staining reagent that can be used on auto-stainers as well as hand staining.

It is still a further objective to eliminate hazardous shipping charges of products packaged in containers over 1 liter.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. The reader skilled in the art will recognize other objects and advantages of the present invention, from a reading of the following detailed description, and the appended claims.

### BRIEF DESCRIPTION OF DRAWINGS

FIG. 1 illustrates a digital image demonstrating a tissue sample taken from a section of placenta stained with the composition of the present invention, at a pH of 4.3, in accordance with a preferred embodiment of the present invention;

FIG. 2 illustrates a digital image demonstrating a tissue sample stained with the composition of the present invention, at a pH of 4.7, in accordance with a preferred embodiment of the present invention;

FIG. 3 illustrates a digital image demonstrating a tissue sample stained with the composition of the present invention, at a pH of 5.3, in accordance with a preferred embodiment of the present invention;

FIG. 4 illustrates a digital image demonstrating a tissue sample stained with the composition of the present invention, at a pH of 5.7, in accordance with a preferred embodiment of the present invention;

FIG. 5 illustrates a digital image demonstrating a tissue sample stained with the composition of the present invention, at a pH of 5.8, in accordance with a preferred embodiment of the present invention.

### DETAILED DESCRIPTION OF DRAWINGS

The composition of the present invention includes a staining reagent to provide a more accurate, clear and reproducible staining of biological tissue samples and cells that relate to cytoplasm, various cytoplasmic elements, erythrocytes, eosinophilic granules, and other tissue elements with the exception of nuclear chromatin. Nuclear chromatin is traditionally stained with a hematoxylin solution.

The present invention is used to produce counter stains with nuclear stains such as hematoxylin to allow for cell nuclei differentiation from cytoplasmic components. The composition of the present invention includes a staining component (dye), a buffer, and a solvent. The invention includes a cytoplasmic counterstaining reagent.

In the preferred embodiment, the composition is made by mixing a propylene glycol solvent, eosin-Y, and a buffer, stirring the mixture until the eosin-Y is completely dissolved, and then filtering the mixture. In another embodiment of the present invention, the eosin-Y is the sole dye in the composition.

In another embodiment of the present invention, the composition includes an equivalent amount of one liter of 60% (by volume) propylene glycol (where the diluent in the lesser concentrations is water) buffered with 0.2M acetate buffer to a pH range of 4.6 to 5.0, and 5.0 grams of eosin-Y, where the eosin-Y dye concentration has been corrected to 100% dye content. The eosin-Y is present in a concentration of about 0.1%-2%, by weight.

The buffer used in the propylene glycol solvent in the above-described embodiment is a modified 0.2 molar acetate buffer consisting of sodium acetate/acetic acid. The buffer was modified in such a way that the 60% propylene glycol solvent was used as the buffer solvent as well as the dye solvent.

The above-described modification of the traditional acetate buffer is as follows: 150 mL of 0.2M sodium acetate in 60% propylene; 850 mL of 0.2M glycol propylene glycol, resulting in a pH range of about pH 4.7. The traditional 0.2M acetate buffer in water was not found to be an acceptable buffer, due to the volume of buffer necessary to maintain the desired pH range, and the necessity to increase the molarity of the buffer solutions to achieve the desired pH range. An increase in molarity may result in an undesirable increase in osmolality resulting in cell artifacts.

An acetate buffer was chosen as the preferred buffer. It is an organic buffer that does not precipitate in solutions of propylene glycol or alcohols. Inorganic buffers, such as a phosphate buffer, may precipitate during tissue dehydration or storage of the staining reagent. The use of an inorganic buffer in conjunction with a dye solvent would also present a precipitate issue during dehydration of a stained tissue section. Inorganic buffers have little solubility in traditional dehydrating reagents (alcohol).

Traditionally, when tissue sections are stained with a cytoplasmic stain (counter stain), the staining process is followed by alcoholic solutions to remove excess cytoplasmic stain and to dehydrate the tissue section. As discussed herein, an inorganic buffer would precipitate causing microscopic artifacts, where an organic buffer would be miscible with both propylene glycol and alcohols.

As discussed herein the traditional use of alcoholic staining solutions of eosin-Y, pose a flammable hazard in laboratories. The staining of tissue sections and cells for microscopic examination and analysis is conducted in open containers of the said staining solutions; this is inclusive of manual staining and auto-staining. The use of non-flammable propylene glycol as the staining solvent eliminates the flammable hazards in laboratories. Also, propylene glycol possesses a solubility factor that allows for a low pH 4.0-5.0 without eosin-Y precipitating.

Propylene glycol was chosen over other glycols such as ethylene glycol (antifreeze) due to its non-toxic quality and low environmental impact. Ethylene glycol (antifreeze) may be substituted for propylene glycol in various aqueous mixtures or used alone, but would pose greater health and environmental impacts.

Also discussed herein is the use of a modified acetate buffer to lock in the pH range of the staining solution of eosin-Y, to assure consistent reproducible staining results. More specifically, the buffered pH range of 4.6 to 5.0 of the staining solution assures a cationic charge on cytoplasmic proteins to allow for the staining results of the anionic dyes eosin-Y, to be consistently reproducible, with the absence of a muddy staining result when the tissue has under gone proper fixation.

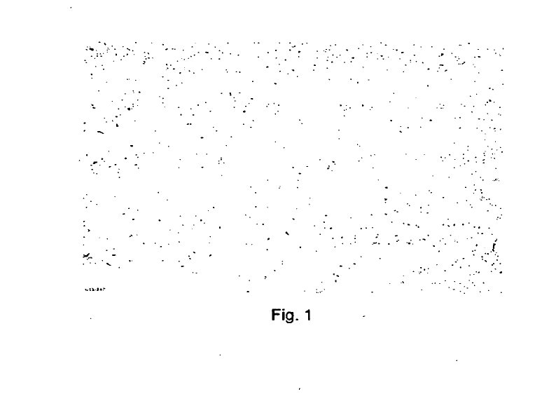

FIG. 1 illustrates a digital image demonstrating a tissue sample stained with the composition of the present invention, at a pH of 4.3. In a first exemplary embodiment, a tissue sample taken from a section of placenta, having a thickness of about 5 microns, stained with the composition of the present invention, at a pH of 4.3. In FIG. 1, the various components of the tissue are clearly visible, and are separable from each other. The results shown—are adequate for use in diagnostic pathology or histology.

The figures are the representations of actual observation resulted through a microscopic slide, at a magnification of about 100×. The cytoplasmic elements are stained in various shades of pink.

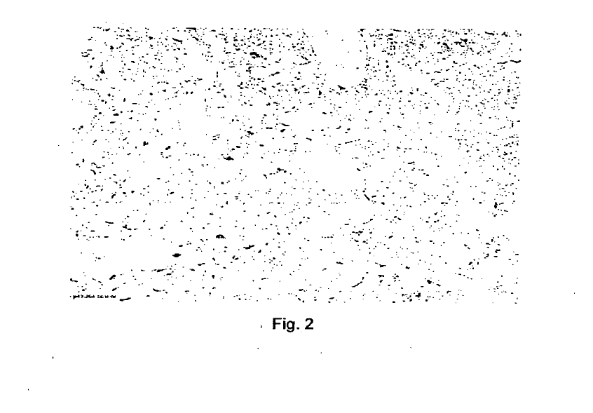

FIG. 2 illustrates a digital image demonstrating a tissue sample stained with the composition of the present invention, at a pH of 4.7. In a second exemplary embodiment, the same tissue sample stained using a staining solution similar to that described above, except that the pH was adjusted to 4.7. As in FIG. 1, the various components of the tissue shown in FIG. 2 are clearly visible, and are separable from each other. The results shown are adequate for use in diagnostic pathology or histology.

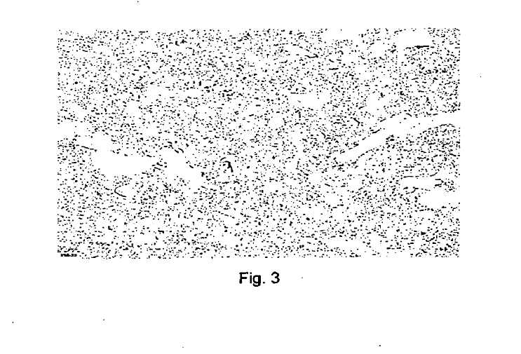

FIG. 3 illustrates a digital image demonstrating a tissue sample stained with the composition of the present invention, at a pH of 5.3. The same tissue sample stained using a staining solution similar to that described above, except that the pH was adjusted to 53. The various components are stained mostly with a light pink color. The components of the tissue are not clearly visible, and not easily separable from each other. The result is not commercially acceptable for use in diagnostic pathology or histology.

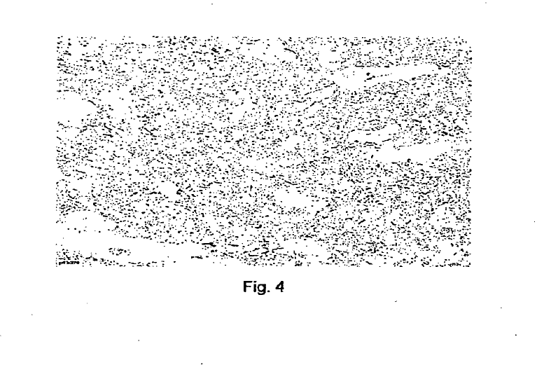

FIG. 4 illustrates a digital image demonstrating a tissue sample stained with the composition of the present invention, at a pH of 5.7. In a fourth exemplary embodiment, the same tissue sample stained using a staining solution as described above, except that the pH was adjusted to 5.7. Again, this result shows most of the tissue components in shades of light pink. The components of the tissue are not readily separable, and this stain is considered unsatisfactory for use in diagnostic pathology or histology.

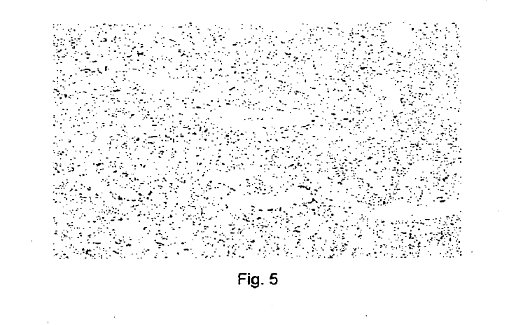

FIG. 5 illustrates a digital image demonstrating a tissue sample stained with the composition of the present invention, at a pH of 5.8. In a fifth exemplary embodiment, the same tissue sample stained using a solution as described above, except that the pH was adjusted to 5.8. Again, the result is unsatisfactory for commercial use. The components of the tissue appear mostly in shades of light pink, and are not clearly distinguishable from each other.

In the present invention the staining solution may work best for pH levels below 5, and especially for pH levels in the range of 4-5. The staining solutions in this range show unexpectedly superior results. Conversely, when the pH of the cytological staining solution is above 5, as disclosed in U.S. Pat. No. 8,445,284, the result is in contrast to that of the claimed range disclosed in the present invention and clearly unsatisfactory for use in diagnostic pathology or histology.

Other formulations of the composition of the present invention are possible, with different percentages of propylene glycol. It has been found that when the concentration of propylene glycol is in the range greater than 45% (glycol content), by volume, the eosin will still be soluble. The choice of 60% as the preferred solvent concentration is based on desirable diffusion rate& However, a range greater than 45% glycol produces desirable results.

In particular, the concentration of the solvent is critical, in that it is important that the eosin dye may not precipitate out of solution. If the eosin so precipitates, the solution is not suitable for use in staining. The significance of the limitation of 45% concentration of the solvent is shown by the observation made by performing a series of experiments.

In the experiments summarized in Table 1 shown below, a solution containing 0.5% eosin-Y, is tested with various percentages of propylene glycol in water. The eosin dye content was 93%, and corrected to 100%. Acetic acid is used to achieve a pH of about 4.5-4.8. The following Table 1 shows the results, for various concentrations of propylene glycol in water:

TABLE 1
Observation of Eosin-Y at various concentrations
of propylene glycol in water

| % Propylene Glycol in Water | Observation |
|---|---|
| 61% propylene glycol/30% water | Eosin-Y is soluble: no precipitate |
| | observed |
| 50% propylene glycol/50% water | Eosin-Y is soluble: no precipitate |
| | observed |
| 55% propylene glycol/45% water | Eosin-Y is soluble: no precipitate |
| | observed |
| 45% propylene glycol/55% water | Eosin-Y is not soluble: precipitate |
| | observed |
| 40% propylene glycol/60% water | Eosin-Y is not soluble: precipitate |
| | observed |
| 30% propylene glycol/70% water | Eosin-Y is not soluble: precipitate |
| | observed |
| 20% propylene glycol/80% water | Eosin-Y is not soluble: precipitate |
| | observed |

In general, other glycols or diols can be used as a solvent. The essential characteristics of such a solvent are 1) that the solvent be in liquid form, 2) that the solvent be non-flammable, and 3) that eosin-Y must be soluble in the glycol solvent at a pH of about 4-5. In the present invention, it is important to use an organic buffer, for the reasons given above.

The composition of the present invention has the advantage that it is a single staining solution which requires no mixing of components prior to use. The composition of the present invention is specifically intended for use in cytoplasmic staining.

The composition of the present invention has the advantage of using a propylene glycol solvent, as a dye solvent, in place of ethyl alcohol which is commonly used in staining solutions.

The composition of the present invention has the further advantage that it has a relatively long shelf life, and does not require mixing of components at the point of use. Thus, the composition is prepared at a first location, and stored and/or transported, while still being ready for use at a later time.

The invention can be modified in various ways. For example, as indicated above, other solvents can be used instead of propylene glycol. Other organic buffers may also be used. These and other modifications, which should be apparent to those skilled in the art, should be considered within the spirit and scope of the following claims.

1. A cytoplasmic stain composition comprising:
a solvent, wherein the solvent is from the group of at least one of glycols and diols;
sole eosin-Y dye soluble in the solvent to highlight the cytoplasm; and
an organic buffer for maintaining the mixture of eosin-Y in the solvent in a pH range of 4.0-5.0, wherein the eosin-Y is soluble in the solvent throughout the pH range maintained by the organic buffer.

2. The cytoplasmic stain composition of claim 1, wherein the solvent includes propylene glycol.

3. The cytoplasmic stain composition of claim 2, wherein the propylene glycol is present in a concentration, by volume, of greater than 45%.

4. The cytoplasmic stain composition of claim 1, wherein the organic buffer comprises an acetate buffer.

5. The cytoplasmic stain composition of claim 1, wherein the eosin-Y is present in a concentration of about 0.1%-2%, by weight, wherein the total dye content of the eosin-Y is corrected to 100%.

6. The cytoplasmic stain composition of claim 1, wherein the solvent is selected from the group consisting of 100% propylene glycol, and a mixture of graded propylene glycol greater than 45% (by volume) with the balance being water.

7. The cytoplasmic stain composition of claim 1, wherein the organic buffer is of suitable molar strength to maintain the mixture of eosin-Y in the solvent at a pH range of 4.0-5.0.

8. The cytoplasmic stain composition of claim 1, wherein the organic buffer maintains the mixture of eosin-Y in the solvent at a pH of 4.3.

9. The cytoplasmic stain composition of claim 1, wherein the organic buffer maintains the mixture of eosin-Y in the solvent at a pH of 4.7.

10. A cytoplasmic stain composition comprising:
a solvent, wherein the solvent is from the group of at least one of glycols and diols;
sole eosin-Y dye soluble in the solvent to highlight the cytoplasm; and
an acetate buffer for maintaining the mixture of eosin-Y in the solvent at a pH of 4.3, wherein the eosin-Y is soluble in the solvent throughout the pH range maintained by the acetate buffer.

11. The cytoplasmic stain composition of claim 10, wherein the solvent includes propylene glycol.

12. The cytoplasmic stain composition of claim 11, wherein the propylene glycol is present in a concentration, by volume, of greater than 45%.

13. The cytoplasmic stain composition of claim 10, wherein the eosin-Y is present in a concentration of about 0.1%-2%, by weight, wherein the total dye content of the eosin-Y is corrected to 100%.

14. The cytoplasmic stain composition of claim 10, wherein the solvent is selected from the group consisting of 100% propylene glycol, and a mixture of graded propylene glycol greater than 45% (by volume) with the balance being water.

15. A cytoplasmic stain composition comprising:
a solvent, wherein the solvent is from the group of at least one of glycols and diols;
sole eosin-Y dye soluble in the solvent to highlight the cytoplasm; and
an acetate buffer for maintaining the mixture of eosin-Y in the solvent at a pH of 4.7, wherein the eosin-Y is soluble in the solvent throughout the pH range maintained by the acetate buffer.

16. The cytoplasmic stain composition of claim 15, wherein the solvent includes propylene glycol.

17. The cytoplasmic stain composition of claim 16, wherein the propylene glycol is present in a concentration, by volume, of greater than 45%.

18. The cytoplasmic stain composition of claim 15, wherein the eosin-Y is present in a concentration of about 0.1%-2%, by weight, wherein the total dye content of the eosin-Y is corrected to 100%.

19. The cytoplasmic stain composition of claim 15, wherein the solvent is selected from the group consisting of 100% propylene glycol, and a mixture of graded propylene glycol greater than 45% (by volume) with the balance being water.
